(19) United States
(12) Patent Application Publication
(10) Pub. No.: US 2003/0091031 A1
(43) Pub. Date: May 15, 2003

(54) Variable pricing structure for transmitting packets across a communications link

(75) Inventors: Charles Edward Kuhlmann, Raleigh, NC (US); Francis Edward Noel JR., Durham, NC (US); Ann Marie Rincon, Burlington, VT (US); Rosemary Venema Slager, Cary, NC (US); Norman Clark Strole, Raleigh, NC (US)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY (US)

(21) Appl. No.: 10/218,730

(22) Filed: Aug. 12, 2002

Related U.S. Application Data
(60) Provisional application No. 60/333,087, filed on Nov. 14, 2001.

(51) Int. Cl. H04L 12/66

(52) U.S. Cl. 370/352

(57) ABSTRACT

A method, system and computer program product for using a variable pricing structure for transmitting packets across a communications link. A variable pricing structure including a plurality of pricing options may be generated by a processor in a gateway by counting the number of packets received from a customer as well as analyzing those received packets. The generated variable pricing structure embodied in a billing record may be transmitted to the customer. The customer upon receiving the billing record may select a pricing option based on one or more criteria, e.g., file size, transmission rate. The packets to be transmitted by the customer to a network device via the gateway may be temporarily stored by an equipment coupled to the customer if the one or more criteria upon which the selected pricing option is based exceed a threshold value thereby ensuring that the customer does not incur extra charges.

### CROSS REFERENCE TO RELATED APPLICATIONS

This application is related to the following commonly owned copending U.S. Patent Applications:

Provisional Application Serial No. 60/333,087, filed Nov. 14, 2001, and claims benefit of its earlier filing date under 35 U.S.C. 19(e); and

Ser. No. ______ (Attorney Docket No. RPS920010179US2) entitled “Mechanism for Tracking Traffic Statistics on a per Packet Basis to Enable Variable Price Billing” filed ______.

### TECHNICAL FIELD

The present invention relates to the field of communication networks, and more particularly to providing a system for using a variable pricing structure for transmitting packets of data across a communications link or through a communications network.

### BACKGROUND INFORMATION

A communications network may generally be defined as a collection of computers or computing systems which interact or transmit data between one network device, e.g., client, router, gateway, and another network device, e.g., server. The connection between each network device, e.g., client, router, gateway, may be referred to as a “communication link.” For example, a communications network may comprise a host machine, e.g., server computer on the Internet commonly referred to as a web server, connected to one or more computers commonly referred to as clients via the Internet. The Internet may refer to a network of networks. Users of clients, commonly referred to as customers, including businesses and individuals, may be connected to the Internet through a gateway, e.g., Internet Service Provider (ISP). The gateway may provide access to the Internet for a fixed monthly fee. That is, customers may be charged a fixed fee regardless of when the customer transfers data or the amount of data transferred by the customer.

Often times, a customer may transmit packets of data, e.g., Internet Protocol (IP) packets of data, to the gateway during peak traffic hours. That is, a customer may transmit data during peak busy times of the day and not transmit data during the off-peak times of the day. By transmitting data during peak busy times of the day, the customer may experience network congestion. Furthermore, the customer is paying for use of the communication link during off peak times despite the fact that the customer may not use the link. That is, the link between the customer and the gateway must either be able to handle the peak rate bandwidth, at a greater cost, or the customer will face network congestion during times of peak traffic. In either circumstance, there may be significant idle bandwidth during off peak hours.

If customers were billed based on other factors, e.g., the time of day the packets of data were transmitted, the number of packets transmitted per unit of time, instead of a simple fixed fee, then the customer may be motivated to transmit data during off-peak times or distributed over time thereby saving money. Furthermore, by transmitting data during off-peak times, network congestion may at least in part be lessened. Furthermore, gateways may benefit by reducing capital costs based on maximizing use of the bandwidth of the communication link.

It would therefore be desirable to provide a system for managing a variable pricing structure, e.g., per packet billing based on time of day, for transmitting packets of data across a communications link including mechanisms whereby a customer may balance its data traffic in response to the pricing structure.

### SUMMARY

The problems outlined above may at least in part be solved in some embodiments by generating a variable pricing structure for transmitting packets of data to network devices, e.g., servers, via gateways, e.g., internet service providers. The variable pricing structure including a plurality of pricing options may be generated by a network processor in the gateway by counting the number of packets received from a customer within a unit of time as well as analyzing those received packets. Analyzing may include, but not limited to: determining the time the packets are received, determining the type of quality of service to be performed on the received packets, measuring traffic volume, determining the type of carrier service, e.g., wired, wireless, optical, determining any customer attributes, e.g., discounts for loyal customers, determining the relationship between the source and destination site, e.g., same company, same family, determining the size of the received packets, determining the type of protocol conversions, e.g., digital source to an analog destination, determining the number of destinations. Upon generating the variable pricing structure, the variable pricing structure, that may be embodied in a billing record, may be transmitted to the customer whose packets were counted and analyzed detailing the costs of various pricing options. The customer may upon receiving the billing record select a particular pricing option. Each pricing option may be based on one or more criteria, e.g., file size, transmission rate, time of day packets are transmitted, quality of service, traffic volume, type of carrier service, customer attributes, relationship between source and destination entities, size of packets, protocol conversions, and number of destinations. The packets to be transmitted to a network device, e.g., server, in a session via a gateway may be monitored by an equipment commonly referred to herein as a customer premise equipment. The customer premise equipment may determine if the one or more criteria from which the selected pricing option is based exceed a threshold value thereby ensuring that the customer does not incur extra charges. The threshold value may be based on the one or more criteria from which the selected pricing option is based. If the one or more criteria exceed the threshold value, then those packets may be transmitted to a local storage unit to be stored temporarily and transmitted at a later point in time when the customer will not incur extra charges.

In one embodiment of the present invention, a method for generating a variable pricing structure for a customer, including a business and an individual, for transmitting packets of data to a network device, e.g., server, via a gateway, may comprise the step of a network processor of the gateway counting the number of packets of data the gateway has received from the customer, e.g., user of a client, within a unit of time. Furthermore, the network processor of the gateway may analyze those packets received. Analyzing the packets of data may include but not limited to: tracking the time the packets are received, determining the type of quality of service to be performed on the received packets, measuring traffic volume, determining the type of carrier service, e.g., wired, wireless, optical, determining any customer attributes, e.g., discounts for loyal customers, determining the relationship between the source and destination site, e.g., same company, same family, determining the size of the received packets, determining the type of protocol conversions, e.g., digital source to an analog destination, determining the number of destinations.

Based on the number of packets received and the analysis performed on those packets, the network processor of the gateway may compute billing rates for a plurality of pricing options. Each pricing option may be based upon one or more different variables including but not limited to: the number of packets transmitted per unit of time, the time the packets are transmitted, the quality of service, the traffic volume, the type of carrier service, customer attributes, the relationship between the source and destination site, the size of the packets, protocol conversions, and the number of destinations.

The network processor of the gateway may then insert the billing rates for a plurality of pricing options computed into a billing record for a particular customer, e.g., the user of the client whose transmitted packets were counted and analyzed. Further, the network processor of the gateway may insert a recommendation to select a particular pricing option for the customer in the billing record.

The network processor of the gateway may then transmit the billing record to the customer.

In one embodiment of the present invention, a method for a customer, e.g., user of a client, to use a variable pricing structure generated by a gateway, e.g., internet service provider, for transmitting packets of data to a network device, e.g., server, via the gateway may comprise the step of the customer selecting one of a plurality of pricing options such as from a billing record received from the gateway. Each pricing option may be based on one or more criteria, e.g., file size, transmission rate, time of day packets are transmitted, quality of service, traffic volume, type of carrier service, customer attributes, relationship between source and destination entities, size of packets, protocol conversions, and number of destinations. The customer may establish a session with the network device, e.g., server, via the gateway where the session is charged based on the selected pricing option.

An equipment, commonly referred to herein as a Customer Premise Equipment (CPE), coupled to the client, may receive a collection of packets of data to be transmitted in a session to the network device via the gateway from the customer. A network processor in the CPE may determine if the one or more criteria from which the selected pricing option is based exceed a threshold value where the threshold value may be based on the one or more criteria. For example, the customer may have selected a pricing option that costs 0.001 cents per second for transmitting 0.1575 Mbps of data to the gateway. If the amount of data transmitted exceeds 0.1575 Mbps, then the customer may be subject to a surcharge. Hence, in this example, the threshold value may be 0.1575 Mbps. In another example, the customer may have selected a pricing option that allows the customer to transmit a file up to the size of 1 Megabyte. If the file transmitted exceeds the size of 1 Megabyte, then the customer may be subject to a surcharge. Hence, in this example, the threshold value may be a file size of 1 Megabyte. In another example, the customer may have selected a pricing option that allows the customer to transmit up to 10 Megabytes at 1 Mbps. If the amount of data transmitted exceeds either the size of 10 Megabytes or the transmission rate of 1 Mbps, then the customer may be subject to a surcharge. Hence, in this example, the threshold value may be a file size of 10 Megabytes with a transmission rate of 1 Mbps.

If the one or more criteria from which the selected pricing option is based do not exceed the threshold value, then the network processor of the CPE may transmit the received packets for the session to the network device, e.g., server, via the gateway.

If the one or more criteria from which the selected pricing option is based exceed the threshold value, then the network processor of the CPE may determine if the packets received by the CPE are high priority packets. That is, the network processor of the CPE may determine if the packets received by the CPE are of such a priority that they should be transmitted to the network device via the gateway despite exceeding the threshold value. Transmitting a number of packets exceeding the threshold value may result in the customer incurring extra charges from the gateway.

If the collection of packets received by the CPE are high priority packets, then the network processor of the CPE may transmit the received collection of packets for the session to the remote network device, e.g., server, via the gateway 104. If, however, the packets received by the CPE are not high priority packets, then the network processor of the CPE may transfer the collection of received packets for the session to a local storage unit for temporary storage. Upon transferring the non-high-priority packets to the local storage unit, a record may be created in a data structure where the record may store information, e.g., file size, source and destination host, regarding the particular collection of session packets stored in the local storage unit. The collection of received packets for the session may be retained in the local storage unit until either the packet criteria is below the threshold value, exit out of the peak time of day, the threshold value increases to an appropriate level or the priority of the stored session packets increases to an appropriate priority level. These determinations may be made by a background process implemented by the network processor of the CPE.

The foregoing has outlined rather broadly the features and technical advantages of one or more embodiments of the present invention in order that the detailed description of the invention that follows may be better understood. Additional features and advantages of the invention will be described hereinafter which form the subject of the claims of the invention.

### BRIEF DESCRIPTION OF THE DRAWINGS

A better understanding of the present invention can be obtained when the following detailed description is considered in conjunction with the following drawings, in which:

FIG. 1 illustrates a network system configured in accordance with the present invention;

FIG. 2 illustrates a client in the network system configured in accordance with the present invention;

FIG. 3 illustrates a server in the network system configured in accordance with the present invention;

FIG. 4 illustrates a customer premise equipment and a gateway in the network system configured in accordance with the present invention;

FIG. 5 is a flowchart of a method for generating a variable pricing structure in accordance with the present invention;

FIG. 6 is a flowchart of a method for using variable pricing structures for transmitting packets in accordance with the present invention; and

FIG. 7 is a flowchart of a method for determining if the store packets in a local storage unit are to be transmitted to a remote network device via the gateway in accordance with the present invention.

### DETAILED DESCRIPTION

It is noted that even though the description of the present invention describes a customer such as a client using the variable pricing structure of the present invention that other network devices may use such a variable pricing structure to balance its data traffic as well. For example, a server may use the variable pricing structure of the present invention to balance its data traffic, e.g., transmitting downloaded movies. It is further noted that embodiments incorporating other network devices, e.g., server, using the variable pricing structure of the present invention would fall within the scope of the present invention.

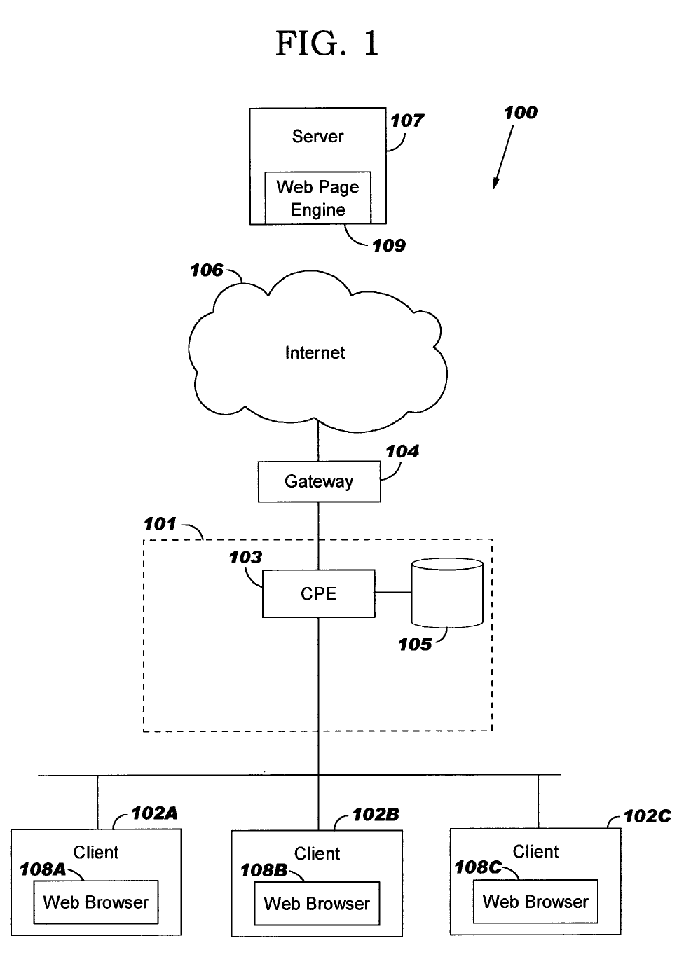

FIG. 1—Network System

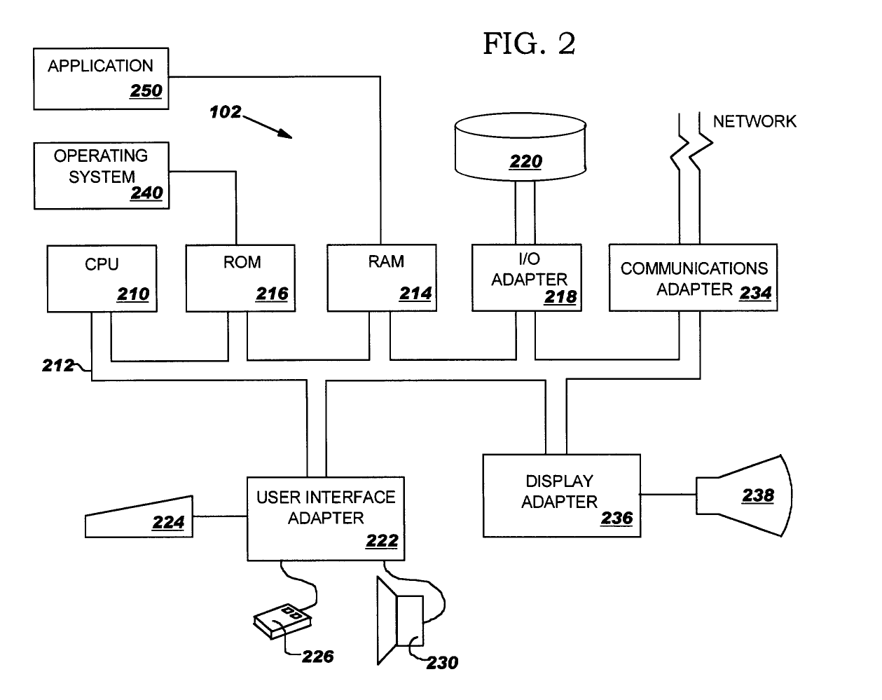

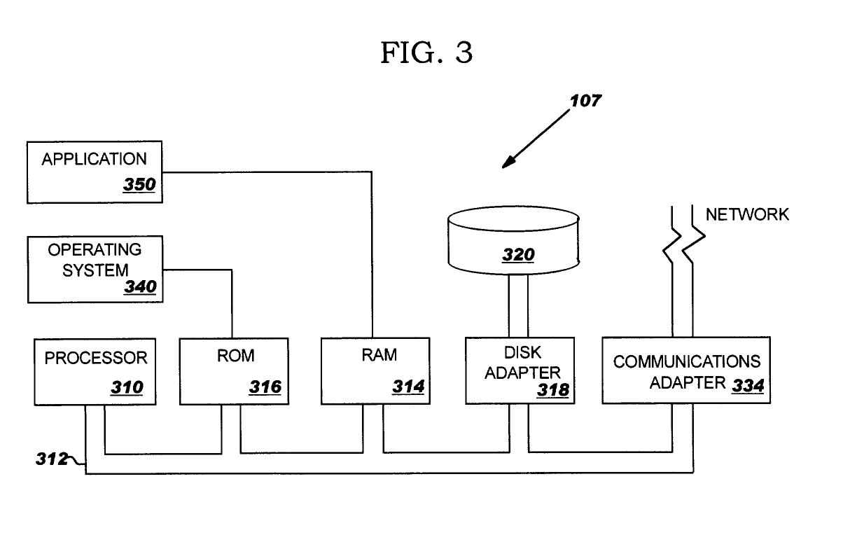

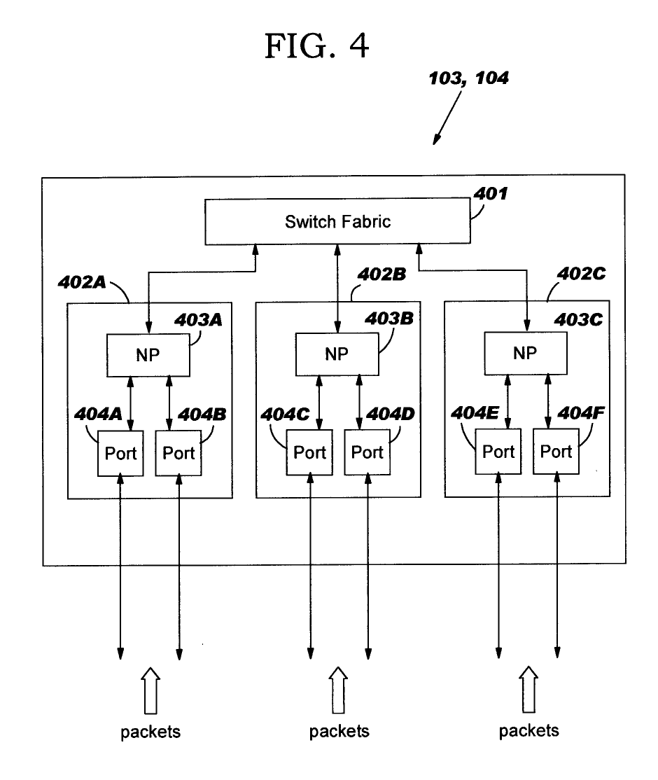

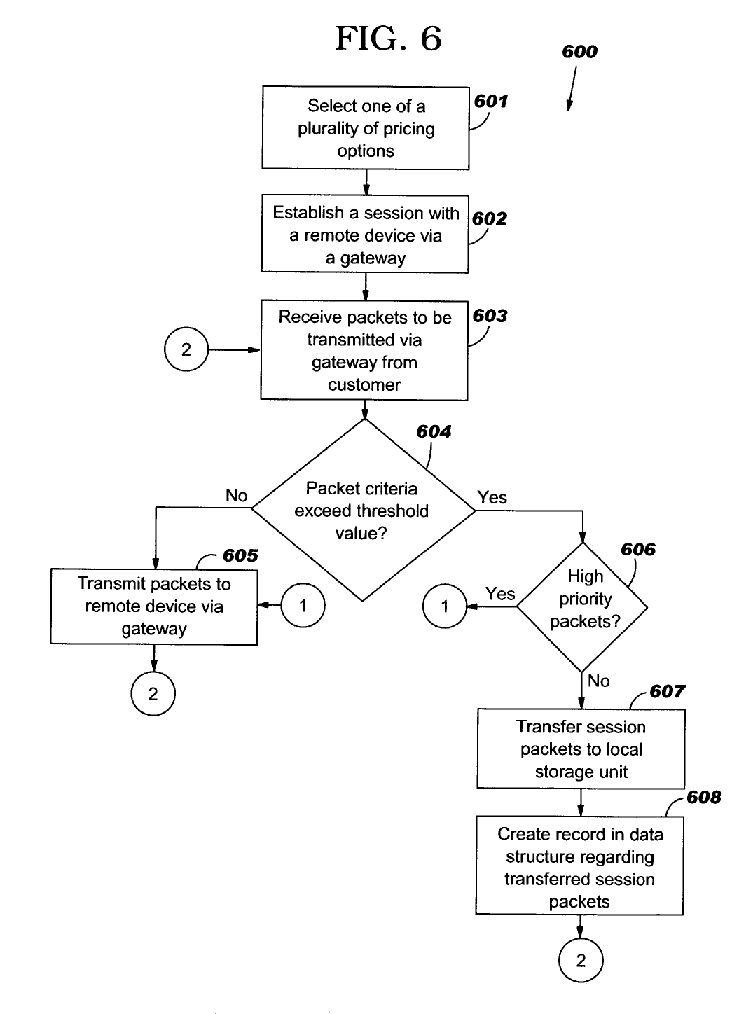

FIG. 1 illustrates an embodiment of a network system 100 in accordance with the present invention. Network system 100 may be divided into multiple subnets 101 where each subnet 101 may be an interconnected, but independent, segment or domain of network system 100. Subnet 101 may comprise one or more clients 102A-C coupled to what is commonly referred to herein as a Customer Premise Equipment (CPE) 103 configured to allow a user of clients 102A-C to manage its data traffic to a gateway 104, e.g., Internet Service Provider (ISP), coupled to subnet 101, in response to a variable pricing structure, e.g., per packet billing based on time of day, as discussed further below in conjunction with FIG. 6. Subnet 101 may further comprise a local storage unit 105 coupled to CPE 103 where local storage unit 105 may be configured to temporarily store packets of data to be transmitted at a later point in time to gateway 104 as discussed in greater detail in conjunction with FIG. 6. Users of clients 102A-C, commonly referred to as customers, including businesses and individuals, may be connected to the Internet 106 through gateway 104 thereby being able to communicate with a server 107, e.g., web server, coupled to the Internet 106. Gateway 104 may be configured to function as an entry/exit point to the Internet 106 whereby gateway 104 performs protocol conversion between different types of networks. Clients 102A-C may collectively or individually be referred to as clients 102 or client 102, respectively. A more detailed description of client 102 is provided below in conjunction with FIG. 2. A more detailed description of server 107 is provided further below in conjunction with FIG. 3. A more detailed description of CPE 103 and gateway 104 are provided further below in conjunction with FIG. 4.

It is noted that the Internet 106 may refer to a network made up of a number of smaller networks. It is further noted that the connection between client 102 and CPE 103 may be any medium type, e.g., wireless, wired. It is further noted that client 102 may be any type of device, e.g., wireless, Personal Digital Assistant (PDA), portable computer system, cell phone, personal computer system, workstation, Internet appliance, configured with the capability of connecting to the Internet 106 and consequently communicating with server 107. It is further noted that network system 100 may be any type of system that has at least one client 102, at least one CPE 103, at least one local storage unit 105, at least one gateway 104, and at least one server 107. It is further noted that network system 100 is not to be limited in scope to any one particular embodiment.

Referring to FIG. 1, each client 102A-C may comprise a web browser 108A-C, respectively, which may be configured for communicating with the Internet 106 and for reading and executing web pages. Browsers 108A-C may collectively or individually be referred to as browsers 108 or browser 108, respectively. While the illustrated client engine is a web browser 108, those skilled in the art will recognize that other client engines may be used in accordance with the present invention.

Server 107, e.g., web server, may comprise a web page engine 109 for maintaining and providing access to an Internet web page which is enabled to forward static web pages to web browser 108 of client 102. Web pages are typically formatted as a markup language file, for example, HyperText Markup Language (HTML) or Extended Markup Language (XML).

FIG. 2—Hardware Configuration of Client

FIG. 2 illustrates a typical hardware configuration of client 102 which is representative of a hardware environment for practicing the present invention. Client 102 may have a central processing unit (CPU) 210 coupled to various other components by system bus 212. An operating system 240 may run on CPU 210 and provide control and coordinate the functions of the various components of FIG. 2. An application 250 in accordance with the principles of the present invention may run in conjunction with operating system 240 and provide calls to operating system 240 where the calls implement the various functions or services to be performed by application 250. Application 250 may include, for example, web browser 108, a program for entering a session with server 107 (FIG. 1). Read-Only Memory (ROM) 216 may be coupled to system bus 212 and include a basic input/output system (“BIOS”) that controls certain basic functions of client 102. Random access memory (RAM) 214 and Input/Output (I/O) adapter 218 may also be coupled to system bus 212. It should be noted that software components including operating system 240 and application 250 may be loaded into RAM 214 which may be the computer system's main memory for execution. I/O adapter 218 may be a small computer system interface (“SCSI”) adapter that communicates with a disk unit 220, e.g., disk drive. It is noted that web browser 108 may reside in disk unit 220 or in application 250. It is further noted that the program for entering a session with server 107 may reside in disk unit 220 or in application 250.

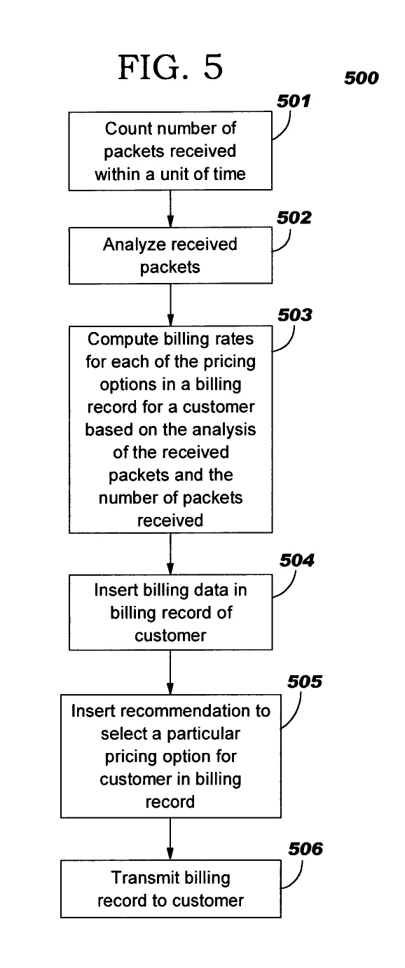

Referring to FIG. 2, client 102 may further comprise a communications adapter 234 coupled to bus 212. Communications adapter 234 may enable client 102 to communicate with CPE 103 (FIG. 1), gateway 104 (FIG. 1), the Internet 106 (FIG. 1), and server 107 (FIG. 1). I/O devices may also be connected to system bus 212 via a user interface adapter 222 and a display adapter 236. Keyboard 224, mouse 226 and speaker 230 may all be interconnected to bus 212 through user interface adapter 222. Event data may be inputted to client 102 through any of these devices. A display monitor 238 may be connected to system bus 212 by display adapter 236. In this manner, a user is capable of inputting, e.g., issuing requests to read web pages, selecting a pricing option in a billing record as discussed in conjunction with FIG. 6, entering a session with server 107 as discussed in conjunction with FIG. 6, transmitting packets of data to CPE 103 to be transmitted to gateway 104 as discussed in conjunction with FIGS. 5 and 6, to client 102 through keyboard 224 or mouse 226 and receiving output from client 102 via display 238.

FIG. 3—Hardware Configuration of Server

FIG. 3 illustrates an embodiment of the present invention of server 107. Referring to FIG. 3, server 107 may comprise a processor 310 coupled to various other components by system bus 312. An operating system 340 may run on CPU 310 and provide control and coordinate the function of the various components of FIG. 3. An application 350 in accordance with the principles of the present invention may run in conjunction with operating system 340 and provide calls to operating system 340 where the calls implement the various functions or services to be performed by application 350. Application 350 may include, for example, a program for operating a web site. Read-Only Memory (ROM) 316 may be coupled to system bus 312 and include a basic input/output system (“BIOS”) that controls certain basic functions of server 107. Random access memory (RAM) 314, disk adapter 318 and communications adapter 334 may also be coupled to system bus 312. RAM 314 may be server's 107 main memory for execution. Disk adapter 318 may be a small computer system interface (“SCSI”) adapter that communicates with disk units 320, e.g., disk drive. Communications adapter 334 may interconnect bus 312 with server 107 enabling server 107 to communicate with gateway 104 (FIG. 1) and client 102 (FIG. 1).

FIG. 4—Hardware Configurations of Gateway and CPE

FIG. 4 illustrates an embodiment of the present invention of CPE 103 (FIG. 1) and gateway 104 (FIG. 1). Referring to FIG. 4, gateway 104 and CPE 103 may be configured to receive packets of data, e.g., Internet Protocol (IP) packets of data, such as from client 102 (FIG. 1), e.g., client 102A, that may be directed to server 107, e.g., web server, in network 100 (FIG. 1).

Returning to FIG. 4, CPE 103, gateway 104 may comprise a switch fabric 401 configured to switch packets of data among the various blades 402A-C coupled to switch fabric 401. Blade 402A may comprise a network processor 403A coupled with one or more ports 404A-B. Blade 402B may comprise a network processor 403B coupled with one or more ports 404C-D. Blade 402C may comprise a network processor 403C coupled with one or more ports 404E-F. Blades 402A-C may collectively or individually be referred to as blades 402 or blade 402, respectively. Network processors 403A-C may collectively or individually be referred to as network processors 403 or network processor 403, respectively. Ports 404A-F may collectively or individually be referred to as ports 404 or port 404, respectively. Each port 404 may be coupled to a particular network device, e.g., gateway 104, client 102, CPE 103, the Internet 106, server, router, in network system 100. Network processors 403 may be configured to receive packets of data to be processed via ports 404 from network devices in the network system. It is noted that CPE 103, gateway 104 may comprise any number of blades 402 and each blade 402 may comprise any number of network processors 403 and ports 404. It is further noted that FIG. 4 is not to be construed in a limiting manner and that FIG. 4 is illustrative.

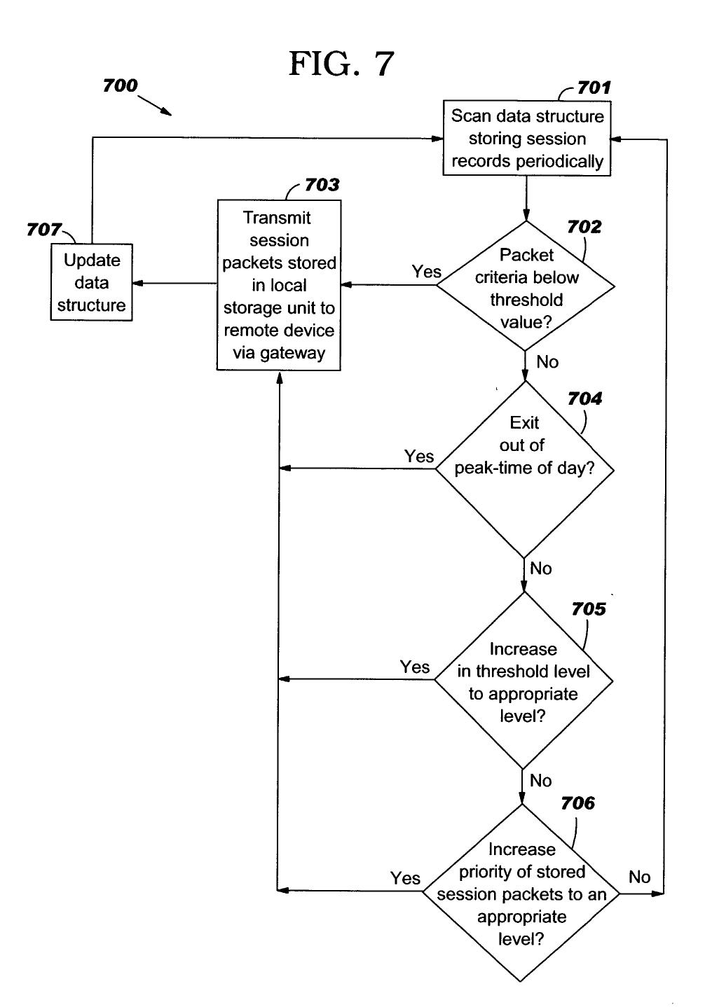

Referring to FIG. 4, network processor 403, e.g., network processor 403A, in gateway 104 may be configured in one embodiment to comprise a memory (not shown), e.g., non-volatile memory, to store a program to perform the steps of a method for generating a variable pricing structure as described below in conjunction with FIG. 5. Network processor 403, e.g., network processor 403A, in CPE 103 may be configured in one embodiment to comprise a memory (not shown), e.g., nonvolatile memory, to store a program to perform some of the steps of a method for allowing a user of client 102 to use a variable pricing structure generated by gateway 104 for transmitting packets of data to gateway 104 as described further below in conjunction with FIG. 6. The memory (not shown) in CPE 103 may further be configured to store a program to perform the steps of a method for determining if any of the collections of session packets stored in local storage unit 105 (FIG. 1) are to be transmitted to a remote network device, e.g., server 107, via gateway 104 as described further below in conjunction with FIG. 7. The memory (not shown) in CPE 103 may further be configured to store a data structure of records where each record may store information, e.g., file size, source and destination host, regarding a particular collection of session packets. Network processor 403 for both CPE 103 and gateway 104 may further comprise a processor (not shown), commonly referred to as a packet processor, coupled to the memory (not shown). The packet processor (not shown) may be configured to execute the instructions of the program. It is further noted that the steps of the method performed by the programs mentioned above may in an alternative embodiment be implemented in hardware such as in an Application Specific Integrated Circuit (ASIC).

FIG. 5—Method for Generating a Variable Pricing Structure

FIG. 5 is a flowchart of one embodiment of the present invention of a method 500 for generating a variable pricing structure for a user of client 102 (FIGS. 1 and 2), commonly referred to as a customer, including a business and an individual, for transmitting packets of data to gateway 104 (FIGS. 1 and 4).

Referring to FIG. 5, in conjunction with FIGS. 1 and 4, in step 501, network processor 403 of gateway 104 may count the number of packets of data gateway 104 has received from a particular customer, e.g., client 102, server 107, within a unit of time. In step 502, network processor 403 of gateway 104 may analyze the packets received in step 501. Analyzing the packets of data may include but not limited to: tracking the time the packets are received, determining the type of quality of service to be performed on the received packets, measuring traffic volume, determining the type of carrier service, e.g., wired, wireless, optical, determining any customer attributes, e.g., discounts for loyal customers, determining the relationship between the source and destination site, e.g., same company, same family, determining the size of the received packets, determining the type of protocol conversions, e.g., digital source to an analog destination, determining the number of destinations. Additional details regarding counting and analyzing received packets are described in U.S. patent application Ser. No. ______, entitled “Mechanism for Tracking Traffic Statistics on a per Packet Basis to Enable Variable Price Billing,” [Attorney Docket No. RPS920010179US2], which is hereby incorporated herein in its entirety by reference.

Based on the number of packets received in step 501 and the analysis performed on those packets in step 502, network processor 403 of gateway 104 may compute billing rates for a plurality of pricing options in step 503. Each pricing option may be based upon one or more different variables including but not limited to: the number of packets transmitted per unit of time, the time the packets are transmitted, the quality of service, the traffic volume, the type of carrier service, customer attributes, the relationship between the source and destination site, the size of the packets, protocol conversions, and the number of destinations.

In step 504, network processor 403 of gateway 104 may insert the billing rates for a plurality of pricing options computed in step 503 into a billing record for a particular customer, e.g., the user of client 102 whose transmitted packets were counted and analyzed in steps 501 and 502. In step 505, network processor 403 of gateway 104 may insert a recommendation to select a particular pricing option for the customer in the billing record. In one embodiment, the pricing option recommended may be based on the billing rates computed in step 503.

In step 506, network processor 403 of gateway 104 may transmit the billing record to the customer, e.g., the user of client 102 whose transmitted packets were counted and analyzed in steps 501 and 502.

It is noted that method 500 may be executed in a different order presented and that the order presented in the discussion of FIG. 5 is illustrative. It is further noted that certain steps in FIG. 5, e.g., steps 501 and 502, steps 504 and 505, may be executed almost concurrently.

FIG. 6—Method for Using a Variable Pricing Structure for Transmitting Packets

FIG. 6 is a flowchart of one embodiment of the present invention of a method 600 for a customer, e.g., user of client 102 (FIGS. 1 and 2), user of server 107 (FIGS. 1 and 3), to use a variable pricing structure generated by gateway 104 (FIGS. 1 and 4), as described in FIG. 5, for transmitting packets of data to a remote device, e.g., server 107, via gateway 104.

Referring to FIG. 6, in conjunction with FIGS. 1 and 4, in step 601, a customer, e.g., a user of client 102, user of server 107, may select one of a plurality of pricing options such as from a billing record received from gateway 104, e.g., ISP. Each pricing option may be based on one or more criteria, e.g., file size, transmission rate, time of day packets are transmitted, quality of service, traffic volume, type of carrier service, customer attributes, relationship between source and destination entities, size of packets, protocol conversions, and number of destinations.

In step 602, the customer, e.g., user of client 102, may establish a session with a network device, e.g., server 107, via gateway 104 where the session is charged based on the selected pricing option.

In step 603, CPE 103 may receive a collection of packets of data to be transmitted in a session to a network device, e.g., server 107, via gateway 104 from the customer, e.g., user of client 102.

In step 604, network processor 403 of CPE 103 may determine if the one or more criteria from which the selected pricing option is based, commonly referred to herein as “packet criteria”, exceeds a threshold value where the threshold value may be based on the one or more criteria. For example, the customer may have selected a pricing option that costs 0.001 cents per second for transmitting 0.1575 Mbps of data to gateway 104. If the amount of data transmitted exceeds 0.1575 Mbps, then the customer may be subject to a surcharge. Hence, in this example, the threshold value may be 0.1575 Mbps. In another example, the customer may have selected a pricing option that allows the customer to transmit a file up to the size of 1 Megabyte. If the file transmitted exceeds the size of 1 Megabyte, then the customer may be subject to a surcharge. Hence, in this example, the threshold value may be a file size of 1 Megabyte. In another example, the customer may have selected a pricing option that allows the customer to transmit up to 10 Megabytes at 1 Mbps. If the amount of data transmitted exceeds either the size of 10 Megabytes or the transmission rate of 1 Mbps, then the customer may be subject to a surcharge. Hence, in this example, the threshold value may be a file size of 10 Megabytes with a transmission rate of 1 Mbps.

If the packet criteria does not exceed the threshold value, then, in step 605, network processor 403 of CPE 103 may transmit the received packets for the session to the network device, e.g., server 107, via gateway 104.

If the packet criteria exceeds the threshold value, then, in step 606, network processor 403 of CPE 103 may determine if the collection of packets received by CPE 103 are high priority packets. That is, network processor 403 of CPE 103 may determine if the packets received by CPE 103 are of such a priority that they should be transmitted to the network device, e.g., server 107, via gateway 104 despite exceeding the threshold value. Transmitting packets whose packet criteria exceeds the threshold value may result in the customer incurring extra charges from gateway 104.

Returning to step 606, if the collection of packets received by CPE 103 are high priority packets, then network processor 403 of CPE 103 may transmit the received collection of packets for the session to the remote network device, e.g., server 107, via gateway 104 in step 605. If, however, the packets received by CPE 103 are not high priority packets, then, in step 607, network processor 403 of CPE 103 may transmit the collection of received packets for the session to local storage unit 105 for temporary storage. The collection of received packets for the session may be retained in local storage unit 105 until either the packet criteria is below the threshold value, exit out of the peak time of day, the threshold value increases to an appropriate level or the priority of the stored session packets increases to an appropriate priority level. These determinations may be made by a background process implemented by network processor 403 of CPE 103 as discussed further below in conjunction with FIG. 7.

In step 608, a record may be created in a data structure where the record may store information, e.g., file size, source and destination host, regarding the particular collection of session packets stored in local storage unit 105 in step 607.

It is noted that steps 601-602 may be implemented by a customer, e.g., user of client 102. It is further noted that steps 603-608 may be implemented by network processor 403 of CPE 103. It is further noted that method 600 may be executed in a different order presented and that the order presented in the discussion of FIG. 6 is illustrative. For example, step 608 may be executed prior to executing step 607. It is further noted that certain steps in FIG. 6 may be executed almost concurrently.

FIG. 7—Background Process of CPE to Determine if Stored Packets are to be Transmitted to Network Device via Gateway

FIG. 7 is a flowchart of one embodiment of the present invention of a method 700 for determining if any of the collections of session packets stored in local storage unit 105 (FIG. 1) are to be transmitted to a remote network device, e.g., server 107 (FIG. 1), via gateway 104.

Referring to FIG. 7, in conjunction with FIGS. 1 and 4, in step 701, the data structure containing records of information, e.g., file size, source and destination host, regarding particular collections of session packets stored in local storage unit 105 may be scanned by network processor 403 of CPE 103.

In step 702, a determination may be made by network processor 403 of CPE 103 as to whether the packet criteria associated with a particular collection of session packets is at or below a threshold value. If the packet criteria is at or below the threshold value, then, in step 703, then the collection of session packets associated with the packet criteria that is at or below the threshold value may be transmitted by network processor 403 of CPE 103 to the remote network device, e.g., server 107, via gateway 104.

If, however, the packet criteria exceeds the threshold value, then, in step 704, network processor 403 of CPE 103 may determine if the customer, e.g., user of client 102, is exiting out of the peak busy time of the day. Gateway 104, e.g., ISP, may charge a higher service fee for receiving packets during peak busy times of the day and a lower service fee for receiving packets during off-peak times of the day. If the customer is exiting from a peak time of day to an off-peak time of day, the cost of transmitting packets may decrease. Hence, the customer may desire to transmit the session packets upon entering an off-peak time of day from a peak time of day thereby saving costs.

If the customer, e.g., user of client 102, is exiting out of the peak busy time of the day, then, in step 703, one or more collections of session packets may be transmitted by network processor 403 of CPE 103 to the remote network device, e.g., server 107, via gateway 104.

If, however, the customer, i.e., user of client 102, is not exiting out of the peak busy time of day, then, in step 705, network processor 403 of CPE 103 may determine if the threshold level has been increased to an appropriate level. That is, network processor 403 of CPE 103 may determine if the threshold level has been increased to a level such that one or more collection of session packets may be transmitted without incurring extra charges to the customer.

If the threshold level has been increased to an appropriate level, then, in step 703, one or more collections of session packets associated value may be transmitted by network processor 403 of CPE 103 to the remote network device, e.g., server 107, via gateway 104.

If, however, the threshold level has not been increased to an appropriate level, then network processor 403 of CPE 103 may determine if the priority level associated with a collection of session packets has been increased to an appropriate level. That is, network processor 403 of CPE 103 may determine if the priority level associated with a collection of session packets has been increased to a level such that the collection of session packets may be transmitted. For example, the customer may determine to store a collection of session packets in local storage unit 105 no longer than three hours. If, after three hours, the packet criteria has not dropped at or below the threshold value, the customer has not exited out of the peak-time of day and the threshold level has not been increased to an appropriate level, then the priority level associated with that collection of session packets may be increased to an appropriate level, e.g., high priority packets. By increasing the priority level to an appropriate level, e.g., high priority packets, the collection of session packets associated with the increased priority level may be transmitted to a remote network device, e.g., server 107, via gateway 104. Since these packets may be transmitted when the criteria associated with those packets exceeds the threshold value, the customer may incur extra charges from gateway 104.

Returning to step 706, if the priority level associated with a collection of session packets has been increased to an appropriate level, then the collection of session packets associated with the increased priority level may be transmitted by network processor 403 of CPE 103 to the remote network device, e.g., server 107, via gateway 104 in step 703.

If, however, the priority level associated with a collection of session packets has not been increased to an appropriate level, then network processor 403 of CPE 103 may scan the data structure containing records of information regarding particular collections of session packets stored in local storage unit 105 in step 701.

Returning to step 703, upon transmitting one or more collections of session packets to the remote network device, e.g., server 107, via gateway 104, network processor 403 of CPE 103 may update the data structure, e.g., deleting the record associated with the transmitted collection of session packets in the data structure, in step 707. Upon updating the data structure, network processor 403 of CPE 103 may scan the data structure containing records of information regarding particular collections of session packets stored in local storage unit 105 in step 701.

It is noted that method 700 may be executed in a different order presented and that the order presented in the discussion of FIG. 7 is illustrative. For example, step 707 may be executed prior to executing step 703. It is further noted that certain steps in FIG. 7 may be executed almost concurrently.

Although the system, computer program product and method are described in connection with several embodiments, it is not intended to be limited to the specific forms set forth herein; but on the contrary, it is intended to cover such alternatives, modifications and equivalents, as can be reasonably included within the spirit and scope of the invention as defined by the appended claims. It is noted that the headings are used only for organizational purposes and not meant to limit the scope of the description or claims.

1. A method for using a variable pricing structure for transmitting packets of data comprising the steps of:
receiving packets to be transmitted in a session to a network device via a gateway, wherein said session is charged based on a selected pricing option, wherein said selected pricing option is based on one or more criteria;
determining if said one or more criteria exceeds a threshold value, wherein if said one or more criteria exceeds said threshold value then the method further comprises the step of:
determining if said packets to be transmitted to said network device via said gateway are high priority packets, wherein if said packets to be transmitted to said network device via said gateway are not high priority packets, then the method further comprises the step of:
transferring non-high priority session packets to a local storage unit to be transmitted to said network device via said gateway at a later point in time.

2. The method as recited in claim 1, wherein said later point in time occurs when said one or more criteria is at or below said threshold value.

3. The method as recited in claim 1, wherein said later point in time occurs when said threshold value is increased to a pre-selected value.

4. The method as recited in claim 1, wherein said later point in time occurs when exiting out of a peak-time of day.

5. The method as recited in claim 1, wherein said later point in time occurs when a priority level associated with said non-high priority session packets is increased to a pre-selected level.

6. The method as recited in claim 1, wherein if said packets to be transmitted to said network device via said gateway are high priority packets then the method further comprises the step of:
transmitting said high priority packets to said network device via said gateway.

7. The method as recited in claim 6, wherein said high priority packets are transmitted at a higher cost.

8. The method as recited in claim 1, wherein if said one or more criteria does not exceed said threshold value then the method further comprises the step of:
transmitting said packets in said session to said network device via said gateway.

9. The method as recited in claim 1, wherein said one or more criteria comprise at least one or more of the following: file size, transmission rate, time of day packets are transmitted, quality of service, traffic volume, type of carrier service, customer attributes, relationship between source and destination entities, size of packets, protocol conversions, and number of destinations.

10. A computer program product embodied in a machine readable medium for using a variable pricing structure for transmitting packets of data comprising the programming steps of:
receiving packets to be transmitted in a session to a network device via a gateway, wherein said session is charged based on a selected pricing option, wherein said selected pricing option is based on one or more criteria;
determining if said one or more criteria exceeds a threshold value, wherein if said one or more criteria exceeds said threshold value then the computer program product further comprises the programming step of:
determining if said packets to be transmitted to said network device via said gateway are high priority packets, wherein if said packets to be transmitted to said network device via said gateway are not high priority packets, then the computer program product further comprises the programming step of:
transferring non-high priority session packets to a local storage unit to be transmitted to said network device via said gateway at a later point in time.

11. The computer program product as recited in claim 10, wherein said later point in time occurs when said one or more criteria is at or below said threshold value.

12. The computer program product as recited in claim 10, wherein said later point in time occurs when said threshold value is increased to a pre-selected value.

13. The computer program product as recited in claim 10, wherein said later point in time occurs when exiting out of a peak-time of day.

14. The computer program product as recited in claim 10, wherein said later point in time occurs when a priority level associated with said non-high priority session packets is increased to a pre-selected level.

15. The computer program product as recited in claim 10, wherein if said packets to be transmitted to said network device via said gateway are high priority packets then the computer program product further comprises the programming step of:
transmitting said high priority packets to said network device via said gateway.

16. The computer program product as recited in claim 15, wherein said high priority packets are transmitted at a higher cost.

17. The computer program product as recited in claim 10, wherein if said one or more criteria does not exceed said threshold value then the computer program product further comprises the programming step of:
transmitting said packets in said session to said network device via said gateway.

18. The computer program product as recited in claim 1, wherein said one or more criteria comprise at least one or more of the following: file size, transmission rate, time of day packets are transmitted, quality of service, traffic volume, type of carrier service, customer attributes, relationship between source and destination entities, size of packets, protocol conversions, and number of destinations.

19. A system, comprising:
an equipment; and
a storage unit coupled to said equipment, wherein said storage unit is configured to temporarily store packets of data to be transmitted to a network device via a gateway coupled to said equipment, wherein said equipment comprises:
a memory unit operable for storing a computer program for using a variable pricing structure for transmitting packets of data; and
a processor coupled to said memory unit, wherein said processor, responsive to said computer program, comprises:
circuitry operable for receiving packets to be transmitted in a session to said network device via said gateway, wherein said session is charged based on a selected pricing option, wherein said selected pricing option is based on one or more criteria;
circuitry operable for determining if said one or more criteria exceeds a threshold value, wherein if said one or more criteria exceeds said threshold value then said processor further comprises:
circuitry operable for determining if said packets to be transmitted to said network device via said gateway are high priority packets, wherein if said packets to be transmitted to said network device via said gateway are not high priority packets, then said processor further comprises:
circuitry operable for transferring non-high priority session packets to said storage unit to be transmitted to said network device via said gateway at a later point in time.

20. The system as recited in claim 19, wherein said later point in time occurs when said one or more criteria is at or below said threshold value.

21. The system as recited in claim 19, wherein said later point in time occurs when said threshold value is increased to a pre-selected value.

22. The system as recited in claim 19, wherein said later point in time occurs when exiting out of a peak-time of day.

23. The system as recited in claim 19, wherein said later point in time occurs when a priority level associated with said non-high priority session packets is increased to a pre-selected level.

24. The system as recited in claim 19, wherein if said packets to be transmitted to said network device via said gateway are high priority packets then said processor further comprises:
circuitry operable for transmitting said high priority packets to said network device via said gateway.

25. The system as recited in claim 24, wherein said high priority packets are transmitted at a higher cost.

26. The system as recited in claim 19, wherein if said one or more criteria does not exceed said threshold value then said processor further comprises:
circuitry operable for transmitting said packets in said session to said network device via said gateway.

27. The system as recited in claim 19, wherein said one or more criteria comprise at least one or more of the following: file size, transmission rate, time of day packets are transmitted, quality of service, traffic volume, type of carrier service, customer attributes, relationship between source and destination entities, size of packets, protocol conversions, and number of destinations.

28. A method for generating a variable pricing structure for transmitting packets of data comprising the steps of:
counting a number of packets received from a customer within a unit of time;
analyzing said received packets;
computing billing rates for each of a plurality of pricing options in a billing record for said customer based on said analysis of said received packets and said number of received packets counted, wherein each pricing option is based upon one or more different variables;
inserting said billing rates in said billing record of said customer;
inserting a recommendation to select a particular pricing option; and
transmitting said billing record to said customer.

29. The method as recited in claim 28, wherein said variables comprise at least one or more of the following: number of packets transmitted per unit of time, time packets are transmitted, quality of service, traffic volume, type of carrier service, customer attributes, relationship between source and destination site, size of packets, protocol conversions, and number of destinations.

30. A computer program product embodied in a machine readable medium for generating a variable pricing structure for transmitting packets of data comprising the programming steps of
counting a number of packets received from a customer within a unit of time;
analyzing said received packets;
computing billing rates for each of a plurality of pricing options in a billing record for said customer based on said analysis of said received packets and said number of received packets counted, wherein each pricing option is based upon one or more different variables;
inserting said billing rates in said billing record of said customer;
inserting a recommendation to select a particular pricing option; and
transmitting said billing record to said customer.

31. The computer program product as recited in claim 30, wherein said variables comprise at least one or more of the following: number of packets transmitted per unit of time, time packets are transmitted, quality of service, traffic volume, type of carrier service, customer attributes, relationship between source and destination site, size of packets, protocol conversions, and number of destinations.

32. A system, comprising:
a memory unit operable for storing a computer program for generating a variable pricing structure for transmitting packets of data; and
a processor coupled to said memory unit, wherein said processor, responsive to said computer program, comprises:
circuitry operable for counting a number of packets received from a customer within a unit of time;
circuitry operable for analyzing said received packets;
circuitry operable for computing billing rates for each of a plurality of pricing options in a billing record for said customer based on said analysis of said received packets and said number of received packets counted, wherein each pricing option is based upon one or more different variables;
circuitry operable for inserting said billing rates in said billing record of said customer;
circuitry operable for inserting a recommendation to select a particular pricing option; and
circuitry operable for transmitting said billing record to said customer.

33. The system as recited in claim 32, wherein said variables comprise at least one or more of the following: number of packets transmitted per unit of time, time packets are transmitted, quality of service, traffic volume, type of carrier service, customer attributes, relationship between source and destination site, size of packets, protocol conversions, and number of destinations.
